(19) United States
(12) Patent Application Publication
(10) Pub. No.: US 2013/0087940 A1
(43) Pub. Date: Apr. 11, 2013

(54) AUTMATIC ENVELOPE LEAK DETECTION DURING TIRE CURING

(71) Applicants: Robert Young, Simpsonville, SC (US); Stephen Manuel, Flat Rock, NC (US); Norman Christopher, Fountain Inn, SC (US)

(72) Inventors: Robert Young, Simpsonville, SC (US); Stephen Manuel, Flat Rock, NC (US); Norman Christopher, Fountain Inn, SC (US)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/704,466

(22) PCT Filed: Jun. 15, 2010
(86) PCT No.: PCT/US10/38613

§ 371 Date: Dec. 14, 2012

(51) Int. Cl. B29D 30/00

(52) U.S. Cl. CPC B29D 30/0061
USPC 264/36.14; 425/17

(57) ABSTRACT

The present invention includes methods and apparatus for curing retread tires, which includes detecting and controlling a leak in a tire-membrane assembly during such curing operations. The steps of the method include placing a plurality of tire-membrane assemblies within a tire curing chamber; connecting a membrane fluid passage to each curing membrane of each tire-membrane assembly where each passage extends in fluid communication between one of the curing membranes and a pressure source and/or a vacuum source, each membrane fluid passage including a transducer for measuring pressure within the passage and a flow restrictor, in particular embodiments; initiating a curing process; receiving a one or more signal responses from each transducer generated as a function of the fluid pressure within the membrane fluid passages; and determining through a controller whether the signal responses received in the prior step indicate an undesired change in pressure in each curing membrane.

### BACKGROUND OF THE INVENTION

1. Field of the Invention

This invention relates generally to methods and apparatus for curing retreaded tires. More specifically, this invention relates to methods and apparatus for curing retread tires, which includes methods and apparatus for detecting and controlling a leak in a tire-membrane assembly during curing operations of a retreaded tire.

2. Description of the Related Art

A retreaded tire consists of a new tread that is attached to a previously existing tire carcass. The carcass is prepared to receive the new tread by removing the prior tread, such as through buffing operations. The new tread is then applied to the tire carcass and is cured to secure the new tread to the carcass. Methods of curing retreaded tires include placing a retreaded tire at least partially within a flexible curing membrane to create a sealed fluid chamber between the curing membrane and the tire. The combination of a retreaded tire with an installed curing membrane is referred to herein as a tire-membrane assembly.

With reference to FIG. 1, a prior art curing system 110 is shown. In operation, a plurality of tire-membrane assemblies 112 are placed within a tire curing chamber 120, such as an autoclave, in the prior art system 110. Each tire-membrane assembly is then placed in fluid communication with a manifold 130 via a fluid passage 122. The manifold 120 provides a source of pressure or vacuum for use by each fluid passage during particular stages of a retreaded tire curing process, as a pressure source 132 and a vacuum source 134 are operably connected to the manifold.

As stated above, during a retread curing operation, that is, in preparation for and during a retread curing process (i.e., a curing cycle), each tire-membrane assembly may at certain instances be placed under vacuum. While under vacuum, however, the curing chamber is pressurized, such as at atmospheric pressure and pressures. Problems may arise, however, when the tire-membrane assembly develops a leak through its sealed fluid chamber, whereby the pressurized air from the curing chamber enters the sealed fluid chamber and ultimately the manifold through the fluid passage extending from the curing membrane. Because the manifold supplies all tire-membrane assemblies with vacuum or pressurized air through other fluid passages in the system, leaks within one tire-membrane assembly may affect the fluid pressure supplied to other tire-membrane assemblies—which may then compromise the curing of associated tires, as the contaminated fluid pressure may not comply with the curing specifications for the subject tires.

In prior art systems, such as is shown in FIG. 1, leaks are generally recognized in one of two manners. In a first instance, leaks may be determined as the tires are being prepared for a curing process. In preparation for a curing process, the sealed fluid chamber of a tire-membrane assembly 112 is placed under vacuum. Subsequently, an operator attaches to the curing membrane a fluid passage 122 extending from the manifold 130. A manual valve 124 positioned along the fluid passage is closed prior to attachment of the fluid passage, thereby placing the fluid passage under atmospheric pressure. After attachment of the fluid passage, the valve is reopened to apply a vacuum to the tire-membrane assembly from the manifold 130. In an effort to determine whether any tire-membrane assembly is leaking before beginning a curing process, the valve 124 is again closed and a gauge 126 visibly monitored by an operator for any fluctuation in pressure subsequent to the valve being closed. If a leak is present, fluid from the curing chamber, at atmospheric pressure, permeates the sealed fluid chamber of the tire-membrane assembly, and thereby increases the pressure within the fluid chamber and the fluid passage attached to the curing membrane above vacuum. Upon confirming the presence of a leak, the operator manually closes valve 124 and unloads the affected tire-membrane assembly 112. Removal prevents the spread of pressure into the manifold 130 and ultimately to other tire-membrane assemblies, thereby avoiding a non-confirming cure for all tires contained within the curing chamber 120.

In a second instance, leaks are monitored during a curing process, where the temperatures and pressures increase within the curing chamber to cure the new tread to the tire carcass. In such processes, prior art systems detect leaks by determining a pressure change within the manifold 130—and not independently within any fluid passage 122 associated with a particular tire-membrane assembly 112. Leaks are determined by monitoring the pressures within the manifold with a transducer 136 and a controller. The manifold pressure P_{M} is monitored because any leak into a curing membrane will ultimately affect the manifold pressure. For example, during a curing cycle, the curing chamber may be pressurized above atmospheric pressure while the tire-membrane assembly remains under vacuum or at a pressure lower than manifold pressure P_{M}, and if the curing membrane seal is compromised, the influx of pressure will travel through the corresponding fluid passage 122 and into the manifold 130 to increase the manifold pressure P_{M}. By solely monitoring the manifold 130, however, an operator is unable to identify through the controller which tire-membrane assembly or assemblies 112 are sufficiently leaking to cause the undesired change in the manifold pressure P_{M}. In response to a change in manifold pressure, the operators will attempt to identify leaking tire-membrane assemblies by locating and manually inspecting each of the fluid passages 122, such as by touching by hand or by using a temperature sensing instrument. If a passage is warm, it indicates that heated air from the curing chamber has penetrated the fluid passage through an associated curing membrane. If the curing cycle has not endured too long, an operator may manually close the valve 124 associated with the fluid passage of a leaking tire-membrane assembly 112 to prevent any further influx of pressure to the manifold 130. If, however, the leaking assembly 112 is not located within a defined time limit, a non-confirming cure will result not only for the tire associated with the leak, but for all tires located within the curing chamber 120 since the leak has affected all tires through the manifold. Once confirming a non-confirming cure for all tires, each tire is removed and reprocessed (i.e., buffed and retreaded) for subsequent curing, which increases costs and processing time.

In the prior art systems, if a small leak arises, one remedy provides a flow restrictor 140 and a valve 142 positioned within the vent fluid passage 138 to release excess pressure from manifold 130 at a single, controlled rate. Flow restrictor 140 may comprise an orifice positioned within passage 138, whereby the orifice is sized smaller than the inside dimensions of passage 138 to limit fluid flow through passage 138. For example, the orifice may be positioned within a plate, whereby the plate prevents flow from continuing through passage 138 unless the flow passes through the orifice. See FIG. 4, for example. Fluid pressure is not released unless valve 142 is opened. Valve 142 may be controlled by a controller, which may send signals to cause the valve to open when the manifold pressure P_{M} reaches a desired threshold. Because the release of flow and pressure through restrictor 140 is limited, restrictor 140 cannot relieve manifold of greater pressures. If the leak is greater than the restrictor 140 can vent, the manifold pressure P_{M} will rise above a second threshold causing an alarm. The operator is signaled to find the offending tire and isolate it from the manifold by closing a corresponding valve 124. If it is not found in time, or an even higher threshold is met, the cure for all tires is deemed non-conforming.

### SUMMARY OF THE INVENTION

Particular embodiments of the present invention include methods and apparatus for curing retread tires, which includes methods and apparatus for detecting and controlling a leak in a tire-membrane assembly during curing operations of a retreaded tire. Particular embodiments of the present invention include methods for curing retread tires, the methods having steps that include placing a plurality of tire-membrane assemblies within a tire curing chamber of a tire curing system, each tire-membrane assembly comprising a retreaded tire and a flexible curing membrane installed about at least a portion of the retreaded tire to form a sealed fluid chamber between the membrane and the tire. Other steps include connecting a membrane fluid passage to each curing membrane of each tire-membrane assembly where each passage extends in fluid communication between one of the curing membranes and a pressure source and/or a vacuum source, each membrane fluid passage including a transducer for measuring pressure within the passage. Still, other steps include initiating a curing process whereby the fluid within the curing chamber is heated to a desired temperature and pressurized to a desired pressure. Other steps include receiving a one or more signal responses from each transducer, each signal response being generated as a function of the fluid pressure contained within the one of the membrane fluid passages. Yet other steps include determining through a controller whether the one or more signal responses received in the prior step indicate an undesired change in pressure in each corresponding curing membrane. Other steps include closing a valve in operable communication with each membrane fluid passage determined by the controller in the preceding step to have experienced an undesired change in pressure, the step of closing being accomplished by the controller sending a signal for the valve to close.

Particular embodiments of the present invention include computer program products including executable instructions embodied on a non-transitory computer readable storage medium, the computer program product providing instructions for determining leaks within a tire-membrane assembly during retreaded tire curing operations that includes initiating instructions for initiating a curing process whereby the fluid within the curing chamber is heated to a desired temperature and pressurized to a desired pressure; receiving instructions for receiving a one or more signal responses from each transducer, each signal response being generated as a function of the fluid pressure contained within the one of the membrane fluid passages; determining instructions for determining through a controller whether the one or more signal responses received in the prior step indicate an undesired change in pressure in each corresponding curing membrane; and, closing instructions for closing a valve in operable communication with each membrane fluid passage determined by the controller in the preceding step to have experienced an undesired change in pressure, the step of closing being accomplished by the controller sending a signal for the valve to close.

Particular embodiments of the present invention include a system for curing retreaded tires that includes a tire curing chamber in fluid communication with a chamber pressure source, the tire curing chamber being configured to receive a plurality of retreaded tires for curing, a curing membrane being mounted upon each retreaded tire to form a sealed fluid chamber about a tread area of the tire. The system also includes a plurality of membrane fluid passages, each of the membrane fluid passages extending between a membrane connecting portion of the membrane fluid passage and the membrane pressure source and/or the membrane vacuum source, each of the plurality of membrane fluid passages including: a valve capable of controlling the flow of fluid through the passage; and, a transducer operably connected to the membrane fluid passage for measuring the fluid pressure contained within the passage. The system further includes a controller in operable communications with each of the transducers and valves of the membrane fluid passage to control the fluid flow through each of the plurality of membrane fluid passages.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a schematic showing a prior art retreaded tire curing system.

FIG. 2 is a schematic showing an improved retreaded tire curing system in accordance with an embodiment of the invention.

FIG. 3 is a cross-sectional view of a tire-membrane assembly.

FIG. 4 is a cross-sectional perspective view of the flow restrictor of the membrane fluid passage, according to an embodiment of the invention.

FIG. 5 is a schematic showing a programmable logic controller for use with the retread curing system, in accordance with an embodiment of the invention.

FIG. 6 is a view showing a display screen of a user-interface of the retreaded tire curing system, according to an embodiment of the invention.

### DETAILED DESCRIPTION OF PARTICULAR EMBODIMENTS

Particular embodiments of the present invention provide methods and apparatus for curing retreaded tires, which includes methods and apparatus for detecting fluid leaks in tire-membrane assemblies during retreaded tire curing operations. Curing operations include preparations made prior to initiating a curing process, while the curing process includes elevating the heat and pressure within a curing chamber to cure a tread to a tire carcass.

Particular embodiments of such methods may include the step of placing a plurality of tire-membrane assemblies within a tire curing chamber of a tire curing system, each tire-membrane assembly comprising a retreaded tire and a flexible curing membrane installed about at least a portion of the retreaded tire to form a sealed fluid chamber between the membrane and the tire. Before a curing process begins, a plurality of retreaded tires is loaded into a curing chamber of a curing system for curing. A flexible curing membrane is installed on each tire to create a sealed fluid chamber between the membrane and at least a portion of the tire. The flexible curing membrane may comprise any flexible membrane for curing a tire that is known to one of ordinary skill in the art, which may comprise one or more curing membranes arranged about the tire.

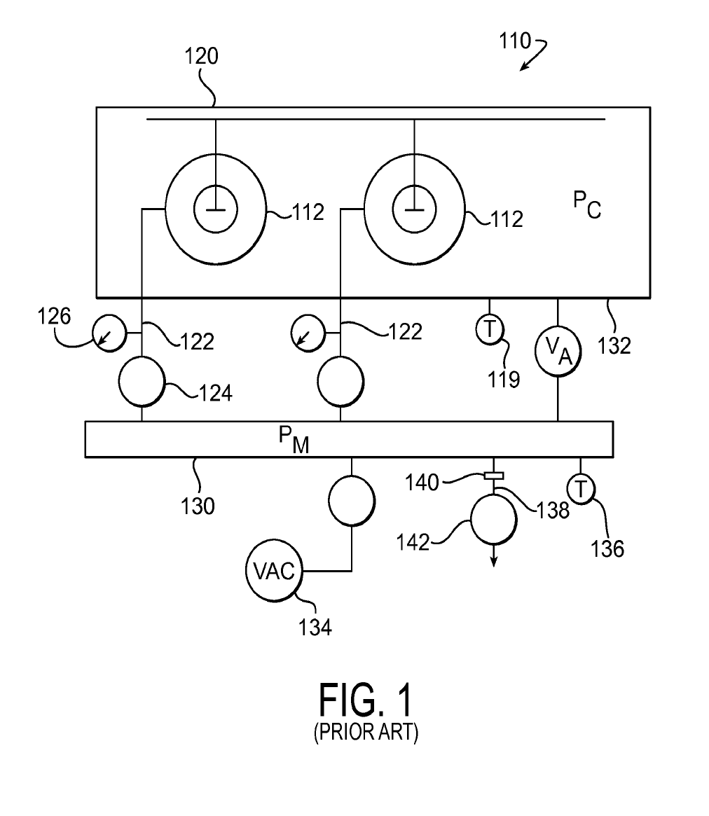

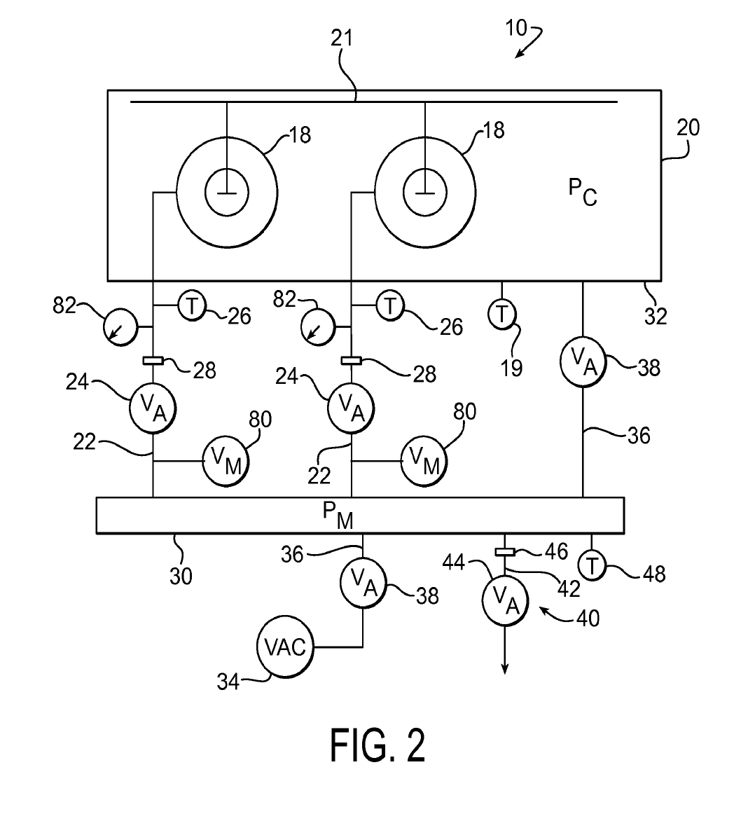

In particular embodiments, such methods may also include the step of placing the sealed fluid chamber of the tire-membrane assembly under substantial vacuum prior to placing the tire-membrane assembly into the curing chamber, or prior to attaching an membrane fluid passage to the curing membrane. As used herein, “vacuum” or “under vacuum” means providing a fluid pressure equal to zero psia (pounds per square inch absolute), and “substantial vacuum” or “substantially under vacuum” means zero psia to less than 5 psia. Tire-membrane assemblies may be loaded into and retained within the curing chamber according to any known method. In the exemplary embodiment shown in FIGS. 1 and 2, the curing chamber includes a track upon which the tire-membrane assemblies are mounted. According to this system, tire-membrane assemblies are loaded and unloaded sequentially, and therefore, when attempting to unload a particular tire-membrane assembly, the assemblies loaded before or after the particular assembly will have to be first unloaded.

Additional steps of such methods may further include connecting a membrane fluid passage to each curing membrane of each tire-membrane assembly where each passage extends in fluid communication between one of the curing membranes and a pressure source and/or a vacuum source, each membrane fluid passage including a transducer for measuring pressure within the passage. According to this step, the membrane fluid passage is placed in fluid communication with a corresponding curing membrane. The fluid passage may comprise a hose, tube, conduit, pipe, or the like, and is also in fluid communication with a membrane pressure source and/or a membrane vacuum source. In particular embodiments, the fluid passage is fluidly connected to a manifold, which operates as both a membrane pressure source and membrane vacuum source, whereby the manifold in fluid communication with a manifold pressure source and a manifold vacuum source. In particular embodiments of the present invention, the manifold includes a manifold transducer for measuring pressure within the manifold. A pressure source may comprise a compressor or any other device known to one of ordinary skill in the art. As the fluid passage may be connected to the pressure and/or vacuum sources prior to the step of operably placing the membrane fluid passage into fluid communication with the curing membrane, a valve in fluid communication with any connected pressure and/or vacuum source is closed to prevent any fluid flow through the fluid passage before connecting the passage to a curing membrane.

Particular embodiment of the inventive methods may include the steps of verifying the connection of each fluid passage to a tire-membrane assembly from the step of connecting before the step of initiating by receiving one or more signal responses from each transducer, the one or more signal responses generated as a function of the fluid pressure contained within the one of the membrane fluid passages over a desired period of time; and determining through the controller whether the one or more signal responses received in the prior step indicate a desired change in pressure in each corresponding curing membrane. These steps may be accomplished by utilizing a programmable logic controller to evaluate signals sent from a transducer representing the fluid pressure within the fluid passage. In particular instances, signals received from the transducer prior to connecting the fluid passage to the curing membrane are compared to signals received after achieving the connection to determine if a fluid pressure change P_{Δ} arises. In other instances, the fluid passage pressure P_{FP} may be compared to a base pressure, such as, for example, atmospheric pressure or the sealed fluid chamber pressure P_{T} measured prior to connection. For example, when the sealed fluid chamber pressure P_{T} of the tire-membrane assembly is maintained at vacuum and the fluid passage pressure P_{FP} is at atmospheric pressure (when the valve is closed between the fluid passage and any pressure and/or vacuum source), the pressure P_{FP} will decrease upon connection of the fluid passage to the curing membrane and the signals received from the transducer before and after the connection will indicate the change in pressure P_{Δ} when compared by the controller. The change in pressure P_{Δ} will indicate a proper connection was achieved.

Particular embodiments of the present invention may further include indicating through the controller that a proper connection was made between each membrane fluid passage and the corresponding tire-membrane assembly when the transducer corresponding to each such tire-membrane assembly fluid passage indicates a desired reduction in pressure subsequent to completing the step of connecting. Once the controller determines a proper connection was achieved, the controller may provide output to a user-interface to indicate to an operator that a proper connection was achieved with a particular mounting location. For example, the output may facilitate a particular change in the display of the user-interface, such as by displaying a text-based message, a signal, or a change in color. An auditory signal or printout may also be provided. Because the curing chamber is capable of receiving a plurality of tires for curing, the user interface will associate the connection with one of a plurality of mounting positions within the curing chamber. If, upon review of the user interface, the operator determines that the tire-membrane assembly was attached to the incorrect fluid passage, and therefore the incorrect mounting position on the user interface, the operator can then disconnect the fluid passage from the tire-membrane assembly, select the proper fluid passage, and repeat the step of operably placing the fluid passage in fluid communication with the curing membrane with the newly selected fluid passage. Once a tire-membrane assembly has been properly loaded into the curing chamber and connected to a fluid passage, such methods include repeating the previous steps until the desired quantity of tire-membrane assemblies are loaded into the curing chamber and properly connected to a corresponding fluid passage.

After properly connecting fluid passages to tire-membrane assemblies, steps may be taken to determine whether any leaks exist in the tire-membrane assemblies. Therefore, particular embodiments of the present invention may further include a step of opening the valve associated with each membrane fluid passage for a period of time and then subsequently closing the valve before initiating a curing process. After a tire-membrane assembly has been properly loaded and connected to a fluid passage, the sealed fluid chamber of the tire-membrane assembly is placed under pressure, such as under vacuum by way of the connected fluid passage. Accordingly, particular steps of such methods may further include placing the sealed fluid chamber of the tire-membrane assembly under vacuum by way of the associated fluid passage. In particular embodiments, this step may be achieved by opening a valve positioned along the fluid passage to fluidly connect a vacuum source, such as a manifold being placed under vacuum, with the sealed fluid chamber. To ensure that a proper seal has been achieved about the sealed fluid chamber, further steps of such methods may include closing the fluid connection between the vacuum source and the sealed fluid chamber, which may be achieved by subsequently closing the valve along the fluid passage. After the valve is closed, particular embodiments of the present invention include the step of receiving, before the step of initiating a curing process and after the step of connecting, one or more signal responses from each transducer in operable communication with each membrane fluid passage, the one or more signal responses generated as a function of the fluid pressure contained within each corresponding membrane fluid passage over a desired period of time. After the step of receiving, further steps may include determining through the controller whether the signal responses received in the prior step indicate an undesired change in pressure. For example, an undesired change in pressure exists when the pressure change P_{Δ} exceeds a defined threshold value P_{Δ, L}. In particular embodiments, the step of determining includes comparing the one or more signal responses received in the step of receiving for each of the fluid passages to one or more signals responses received from a transducer in a manifold to determine whether the undesired change in pressure is present within the curing membrane, the manifold signals being generated as a function of the fluid pressure contained within the manifold. In other embodiments, where the step of receiving includes: receiving one or more signal responses from a manifold transducer, the one or more signal responses generated as a function of the fluid pressure contained within the manifold; and, receiving one or more signal responses from a curing chamber transducer, the one or more signal responses generated as a function of the fluid pressure contained within the curing chamber, whereby the step of determining includes calculating a first difference between a curing chamber pressure and a manifold pressure at a given time based upon the signals received during the step of receiving, calculating a second difference between a curing chamber pressure and a manifold pressure at a given time based upon the signals received during the step of receiving, and comparing the first difference with the second difference to determine whether an undesired leak is present. For example, to determine a change in pressure P_{Δ}, controller may compare different fluid passage pressure P_{FP} signals obtained over time, or controller may compare the membrane fluid passage pressure P_{FP} signals to manifold pressures P_{M} (or membrane pressure or vacuum source pressures). Curing chamber pressures P_{C} may also be used to identify a pressure change P_{Δ}. See paragraphs [0043]-[0044] for further discussions on methods for determining pressure changes and leaks, which may be employed.

Once an undesired change in pressure or leak is determined, further steps may include identifying each tire-membrane assembly connected to each membrane fluid passage determined to have experienced an undesired change in pressure in the preceding step of determining, the step of indentifying being facilitated by the controller. The step of identifying may be accomplished through a user-interface, an audible alarm or sound, and/or by way of a printer or other similar device.

Particular embodiments of the present invention may include initiating a curing process whereby the fluid within the curing chamber is heated to a desired temperature and pressurized to a desired pressure. In further embodiments, this step may initiate once it is determined that the tire-membrane assemblies loaded within the curing chamber do not have any significant leaks. As the curing operation resumes with beginning a curing process (i.e., a curing cycle), heated fluid (such as air) is supplied to the curing chamber, which is pressurized to a pressure P_{C} as desired—such as according to a defined curing specification. Likewise, the sealed fluid chamber within the tire-membrane assembly may be placed under vacuum or pressurized to a pressure P_{T} as desired during the curing process. While pressures P_{C} and P_{T} may vary as desired throughout the curing process, particular embodiments provide a sealed fluid chamber pressure P_{T} that is less than the curing chamber pressure P_{C}. Therefore, if a leak develops through a sealed fluid chamber during the curing process, the pressure P_{FP} in a fluid passage directly connected to the associated curing membrane will increase as the higher tire chamber pressure P_{C} initially permeates the sealed fluid chamber and eventually permeate the attached fluid passage. A flow restrictor may be placed along each membrane fluid passage to control the flow rate of fluid within the passage. The flow restrictor will allow slower rates associated with small increases in pressure attributed to small leaks within a tire-membrane assembly. However, when greater pressures associated with larger leaks cause increased fluid flows, the flow restrictor will not allow the fluid to flow at the rates associated with the larger leak. A transducer positioned within each membrane fluid passage is arranged to measure this back-up of increased pressure, allowing a controller to evaluate such pressures.

Accordingly, further steps of such methods may include receiving a one or more signal responses from each transducer, each signal response being generated as a function of the fluid pressure contained within the one of the membrane fluid passages and then determining through a controller whether the one or more signal responses received in the prior step indicate an undesired change in pressure in each corresponding curing membrane. In particular embodiments, the step of determining includes assessing whether the undesired change in pressure is above a defined threshold value. For example, to determine a change in pressure P_{Δ}, controller may compare different fluid passage pressure P_{FP} signals obtained over time, or controller may compare the membrane fluid passage pressure P_{FP} signals to manifold pressures P_{M} (or membrane pressure or vacuum source pressures). Curing chamber pressures P_{C} may also be used to identify a pressure change P_{Δ}. See paragraphs [0043]-[0044] for further discussions on methods for determining pressure changes and leaks, which may be employed. If it is determined that a leak has arisen, the controller will send a signal to a user interface to indicate to the operator that the sealed fluid chamber within a particular tire-membrane has been breached with a fluid leak. If the leak was detected within a specified period of time T subsequent to the initiation of the curing process, the defective tire-membrane assembly may be removed from the curing chamber for curing at a later time without a need for reprocessing. If, however, the leak was not detected until a time after the specified period of time T in which tire removal is allowable, the fluid passage valve associated with the leaking tire-membrane assembly is closed to prevent the leak from affecting the vacuum or pressure source, and the affected tire, which will be removed after the curing process has completed, will be reprocessed for subsequent recuring. Accordingly, particular embodiments of the present invention may include closing a valve in operable communication with each membrane fluid passage determined by the controller in the preceding step to have experienced an undesired change in pressure, the step of closing being accomplished by the controller sending a signal for the valve to close. In other variations, an operator may manually close the valve or another manually actuated valve positioned along the fluid passage. Further steps may include identifying each tire-membrane assembly connected to each membrane fluid passage having a valve closed in the preceding step of closing, the step of identifying being facilitated by the controller. The step of identifying may be accomplished by a user-interface, an audible alarm or signal, and/or a printer or the like.

Particular embodiments of the present invention include repeating the steps of receiving, determining, and closing recited in paragraph [0026] for each of the membrane fluid passages for a second desired time period during the curing process. The methods and steps described herein may be employed, in whole or in part, and repeated continuously or intermittently as desired during the curing operations to monitor pressure changes and determine if any leaks in any tire-membrane assembly are present. If a leak is detected, particular steps according to the methods and apparatus described herein are employed to remedy or isolate any such leak.

The methods described herein may be employed by a retreaded tire curing system and embodied in computer software as instructions, such as those embodied on a non-transitory computer readable storage medium, for example. Exemplary embodiments of a retread curing system for use in performing such methods are discussed in further detail below.

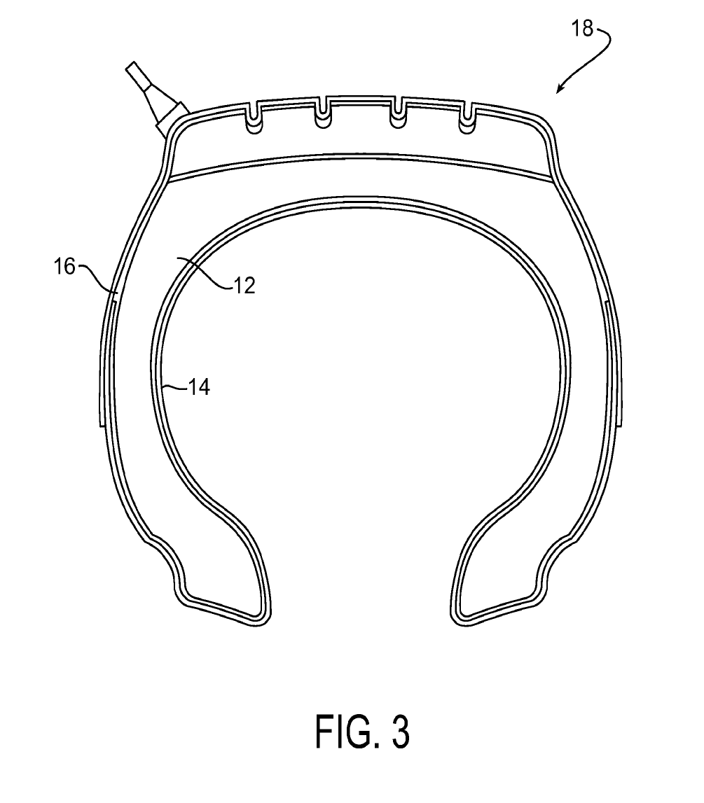

A retreaded tire curing system 10 for use in the methods described herein is generally shown in FIG. 2. Curing system 10 includes a tire curing chamber or vessel 20 that is in fluid communication with a chamber pressure source (not shown). In operation, one or more retreaded tires 12 are placed within the chamber 20 for subsequent curing, and may be suspended by a track 21 as shown, for example. Curing chamber 20 includes a transducer 19 placed in operable communication therewith for measuring curing chamber pressures P_{C}, which may be sent to a controller 50 as signals for use in determining leaks within any tire-membrane assemblies. With reference to FIG. 3, each retreaded tire 12 is at least partially surrounded by a curing membrane 14 prior to curing to form a sealed fluid chamber 16 between the curing membrane and at least a portion of the tire. Curing membrane 14 may comprise any flexible curing membrane known to one of ordinary skill in the art, such as one or more envelopes, for example, to create the sealed fluid chamber 16. The combination of a tire 12 with curing membrane 14 is referred to herein as a tire-membrane assembly 18.

Prior to initiating any curing process, each curing membrane 14, and therefore each tire-membrane assembly 18, is placed in fluid communication with a membrane pressure source and/or a membrane vacuum source. With reference to the embodiment of FIG. 2, the membrane pressure and/or vacuum source is a manifold 30, which generally comprises a chamber pressurized and/or placed under vacuum as desired by a manifold pressure source 32 and a manifold vacuum source 34. To achieve the fluid connection between the curing membrane 14 and the manifold 30, a membrane fluid passage 22 is used. A fluid passage may comprise any known apparatus for transferring pressurized or non-pressurized (vacuum) fluids, such as a hose, pipe, conduit, tubing, or the like.

In the embodiment shown in FIG. 2, positioned along membrane fluid passage 22 is a valve 24, a transducer 26, and a flow restrictor 28. Transducer 26 and flow restrictor 28 are positioned between valve 24 and an end of passage 22 for attachment to curing membrane 14, or between valve 24 and curing chamber 20 in other variations. Further, transducer 26 is placed between flow restrictor 26 and the curing membrane 14 along passage 22 for the purpose of measuring any back-up pressure created by fluid flowing from the curing membrane 14 to the flow restrictor 26. Valve 24 controls the flow of fluid between the manifold 30 and the curing membrane 14 (and therefore to the sealed fluid chamber 16), and may comprise any known valve capable of fully or partially restricting fluid flow through fluid passage 22. For example, in particular variations, valve 24 may comprise a pressure regulator valve, which may be used with or without flow restrictor 28 positioned along fluid passage 22. In the embodiment shown, actuation of valve 24 is controlled by a controller 50 to which the valve and/or a valve actuator (not shown) is operably connected. A valve actuator may comprise any known means of actuating a valve, such as a solenoid, for example. In certain instances, the determination to open and close valve 24 is logically determined by a processor 52 based upon stored instructions and/or logic utilizing input received from transducer 26, the transducer sending signals to the controller 50 corresponding to the pressure of the fluid present within fluid passage 22. In other variations, valve 24 is manually actuated, whereby an operator manually actuates valve 24 based upon output received from controller 50 and the signals received from transducer 26. A manual valve 80 and/or a pressure gauge 82 may also be positioned along fluid passage 22 in addition to valve 24.

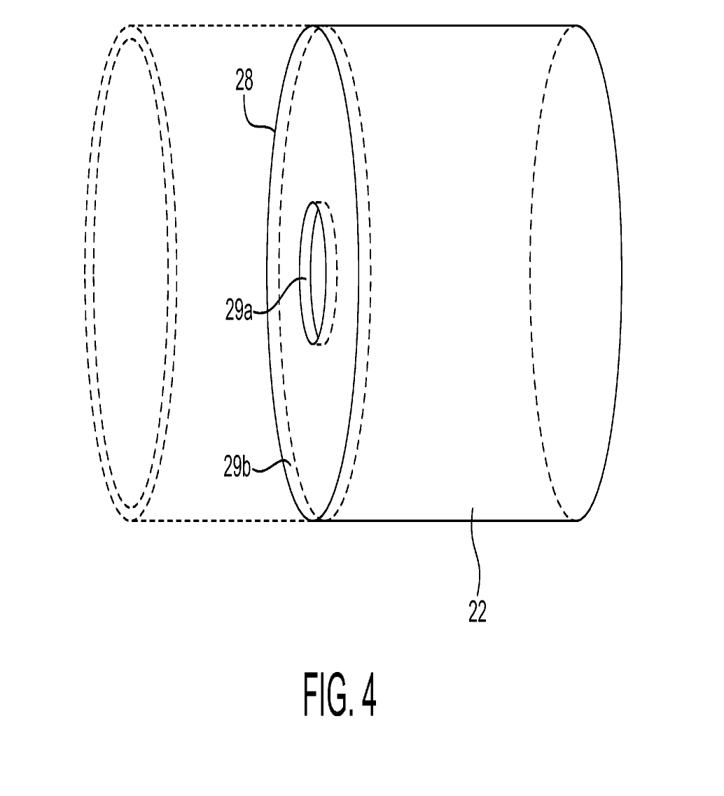

With reference to FIGS. 2 and 4, a flow restrictor 28 is positioned within fluid passage 22 to provide a means of controlling the fluid flow rate within the fluid passage 22. A transducer 26 is positioned along each passage 22 between the flow restrictor 28 and an end of passage 22 for connection to a curing membrane 16. In operation, restrictor 28 allows fluid flow rates within passage 22 up to a maximum rate, whereby increased flow rates associated with the pressures arising from larger leaks in a tire-membrane assembly 18 are unable to completely pass through restrictor 28 to thereby cause an increase in pressure measurable by transducer 26. It is this pressure that is evaluated to determine if the pressure increase is significant to warrant further action by controller 50. In particular embodiments, flow restrictor 28 comprises flow passage reduction, that is, a reduction in the cross-sectional internal opening through which flow passes. In the embodiment shown in FIG. 4, the flow passage reduction comprises an orifice 29a positioned within a plate 29b extending across passage 22. Orifice 28 regulates fluid flow there through according to the size of the orifice opening. According to one embodiment, orifice 28 forms an opening having a diameter of approximately 0.035 inches. Other sized orifice openings may be used to achieve different flow rates as desired for different conditions. Orifice 28 may also comprise a variable opening, which may be controlled by controller 50 in particular variations. In other embodiments, flow restrictor 28 may comprise a reduction in the passage diameter or a pressure regulator or any other similar device known to one of ordinary skill in the art, and may be controlled by controller 50. Still, it is understood that flow restrictors 28 may not be employed in other variations of system 10.

With continued reference to FIG. 2, manifold 30 is a chamber capable of retaining pressurized fluid for the collective use by a plurality of fluid passages 22, and therefore a plurality of tire-membrane assemblies 18. Manifold 30 is placed in fluid communication with both a manifold pressure source 32 and a manifold vacuum source 34 through one or more fluid passages 36. In the embodiment shown, pressure source 32 is the tire curing chamber 20, but in other instances, the pressure source may be a compressor or any other known device capable of pressurizing fluid. As with fluid passage 22, fluid passages 36 may comprise any known apparatus for transferring pressurized or non-pressurized (vacuum) fluids, such as a hose, pipe, conduit, tubing, or the like. Further, each fluid passage 36 includes a valve 38 to restrict the flow of fluid as desired. Valve 38 may form any valve contemplated for valve 24. In the embodiment shown, the actuation of valve 38 is controlled by controller 50, but may be controlled manually in other instances.

In the embodiment shown, manifold 30 includes a vent 40 for releasing small pressure increases from the manifold. To facilitate the release of pressure, vent 40 is in fluid communication with manifold 30 via a fluid passage 42. Fluid passage 42 may form any passage contemplated for passages 22 and 36. Vent 40 also includes a valve 44 and a flow restrictor 46 positioned within fluid passage 42 between the valve 44 and the manifold 30. As with fluid passage 22, flow restrictor 46 controllably releases pressurized fluid to remedy small increases in pressure within manifold 30. Flow restrictor 46 may comprise a plate and orifice as described in FIG. 4 or any other flow restrictor contemplated by restrictor 28. Valve 44 may form any valve contemplated for valves 24 and 38, while the actuation of valve 44 may be controlled by and actuator and controller 50. As with the other valves, valve 44 may be controlled manually in other instances. For the purpose of measuring the fluid pressure within manifold 30, a transducer 48 is placed in operable communication with manifold 30. Transducer 48 is also in operable communication with processor 50, to which transducer 48 provides inputs to assist in the logical operation of system 10.

Each transducer 19, 26, 48 generates a signal response corresponding to the fluid pressure then presently contained within curing chamber 20, fluid passage 22, and manifold 30, respectively. The signal response may be represented by a value, which may represent current, voltage, resistance, or any other characteristic of the signal response. Ultimately, the signal is sent to the programmable logic controller 50 for evaluation and processing by way of any communication means known to one of ordinary skill in the art, such as an input/output (I/O) cable 54, by infrared signal, by radio frequency, by one or more cables, including fiber optics, for example.

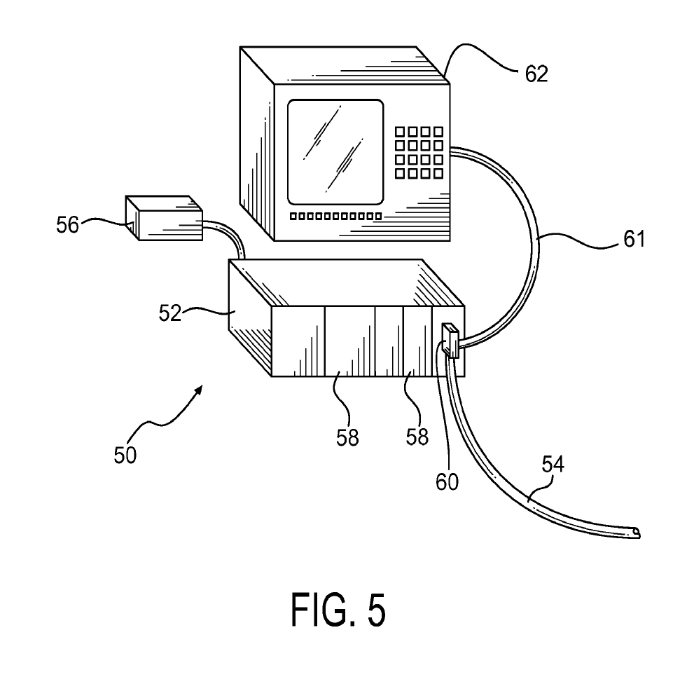

With reference to FIG. 5, programmable logic controller 50 generally receives signal responses from each transducer 19, 26, 48 to monitor and control the flow and pressurization of fluid within tire-membrane assemblies 18 by controlling the actuation of valves 24, 38, 44 and the generation of fluid pressure and vacuum through any pressure and vacuum source. Controller 50 includes a logic processor 52, which may be a microprocessor, a memory storage device 56, such as RAM (random access memory), ROM (read-only memory), PROM (programmable read-only memory), and at least one input/output (I/O) cable 54 for communicating with system 10. Further, controller may include an I/O slot 58 for housing an I/O card having I/O cable connector 60.

An operator may utilize a user-interface 62 to monitor the pressures and the curing operation of system 10, and to initiate operations, program, or otherwise control or instruct, the operation of controller 50 and system 10. User-interface 62 and controller 50 may communicate by way of I/O cable 61 or any other means of communication known to one of ordinary skill, such as by wireless communications, for example. Generally, controller 50 may be programmed by any known graphical or text language. Programmed instructions, data, input, and output may be stored in a memory storage device 56, which is accessible to processor 52. Memory device 56 may comprise any data storage device known to one of ordinary skill in the art, such as hard disk drives, optical storage devices, semiconductor memory such as flash memory, magnetic storage devices, and the like. Processor 52 executes programmed instructions, calculations, and measurements, as wells as other operations and methods discussed herein. Memory storage device 56 also stores inputs, outputs, and other information, such as, for example, data representing pressures measured by transducers 19, 26, 48 for use by processor 52 in performing its operations. Controller 50 may also communicate with a printer or other similar device to communicate output to a user in a physical form, such as printed on paper or any other known medium, for example.

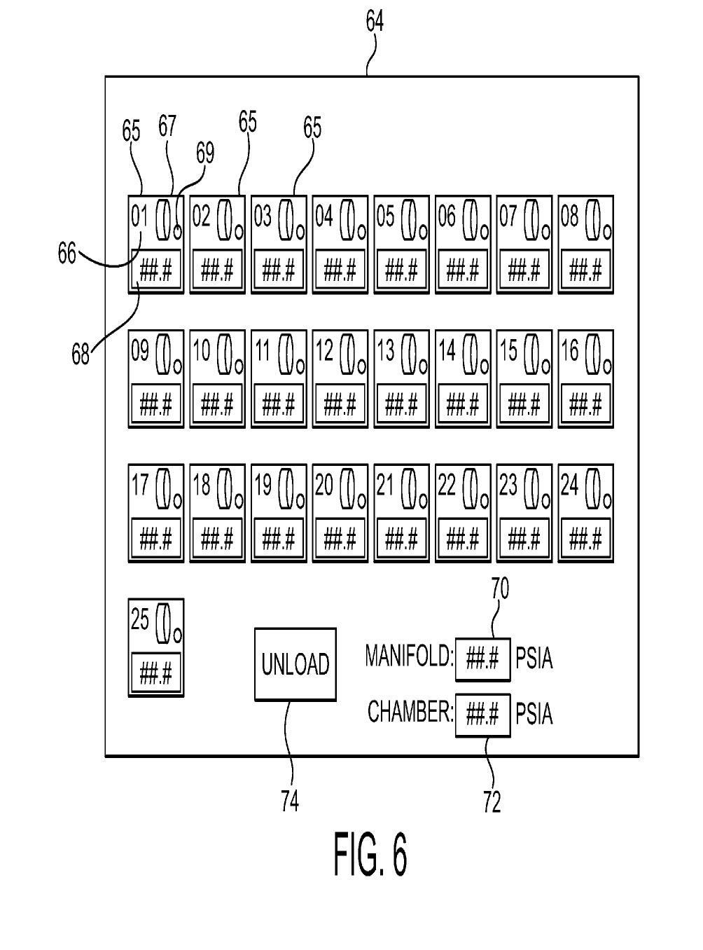

With reference to FIG. 6, an exemplary embodiment of a display screen 64 associated with user-interface 62 is shown. In accordance with the methods described above, in particular embodiments, display screen 64 provides various information and alerts pertaining to each fluid passage 22 and/or tire-membrane assembly 18. For example, display screen 64 provides a plurality of position displays 65 for association with each fluid passage 22 and any tire-membrane assembly 18 attached to such passage 22 within the curing chamber 20. An identifying insignia 66 is used in association with each position display 65 to uniquely identify each position within curing chamber 20. With further regard to each position display 65, the following may also be provided: a selectable icon 67 for an operator to select when desiring to send instructions or input to controller 50; a field 68 identifying the present pressure in fluid passage 22 as measured by transducer 26; and a status identifier 69 indicating to an operator the status of any connected assembly 18, such as when the pressurization of fluid passage 22 is proper or when the pressurization indicates a leak in the sealed fluid chamber 16 within a tire-membrane assembly 18. Display 64 may also include fields identifying the manifold pressure 70 provided by transducer 48 and the curing chamber pressure 72, and may further include a selectable icon 74 to terminate or pause the curing process for the purpose of unloading any leaking tire-membrane assemblies 18 from curing chamber 20. Still, other information, alerts, requests for instructions, and means allowing a user to provide instructions or inputs to controller 50 may be displayed or provided through display 64 in accordance with the methods and other aspects of the inventions described herein.

In operation, according to an exemplary embodiment of the retread curing system 10, an operator loads each tire-membrane assembly 18 into curing chamber 20. Each tire-membrane assembly 18 is then fluidly connected independently to one or more membrane fluid passages 22. The fluid passages 22 in turn are connected to a membrane pressure source and/or a membrane vacuum source. In the embodiment of FIG. 2, a manifold 30 comprises both the membrane vacuum source and the membrane pressure source. Each fluid passage 22 includes a transducer 26 for measuring the pressure within the passage 22.

Upon connection of each fluid passage 22 to a tire-membrane assembly 18, controller 50 determines whether the fluid passage 22 was properly connected to the curing membrane 16 based upon the pressure measurements obtained from a corresponding transducer 26 prior to and subsequent to the connection of the fluid passage 22 to a tire-membrane assembly 18. For example, a proper connection may arise when a reduction of pressure occurs within passage 22 upon connection, such as when the sealed fluid chamber within the tire-membrane assembly 18 is generally placed under vacuum while the fluid passage 22 is at atmospheric pressure prior to attachment of fluid passage 22. For example, a pressure reduction of 5 psi or more may indicate a proper connection. In other variations, a pressure increase or the finding of no change in pressure may indicate a proper connection.

If it is determined that a proper connection occurs between a fluid passage 22 and a tire-membrane assembly 18, controller 50 indicates a successful connection to an operator through user-interface 62—such as by way of display screen 64. For example, for a particular position display 65, status identifier 69 turns blue when a proper connection occurs. Identifier 69 may also indicate no connection or an improper connection, such as by changing the color to yellow. By receiving indication from the controller 50 in association with an identifying insignia 66 that a proper connection has been made, an operator is also able to determine if the tire-membrane assembly 18 was connected to the desired fluid passage 22. For example, after connecting the first tire-assembly 18 with a fluid passage 22 associated with the first identifying insignia 66 labeled “01,” an operator will be able to determine whether the second tire-membrane assembly was properly connected to the second fluid passage 22 or improperly connected to another fluid passage 22 by observing on the display screen 64 whether the newly-altered identifier 69 (i.e., newly changed to blue) was associated with the second identifying insignia 66 labeled “02” or an identifier 69 associated with another identifying insignia 66. If the most recently connected tire-membrane assembly 18 was not connected to the desired fluid assembly 22, the operator may then remove the connection and repeat the connection process with another fluid passage 22 until the desired fluid passage 22 is connected. Upon receiving an indication that a proper connection exists, an operator may engage a selectable icon 67 to indicate that the tire-membrane assembly is mounted in its desired position and to authorize initiation of the next procedural step. After engaging the selectable icon 67, status identifier 69 may be altered to reflect the engagement—such as by changing to the color green, for example.

Once a tire-membrane assembly 18 has been properly connected to a membrane fluid passage 22, steps may be taken to determine if there is any leak in the sealed fluid chamber 16 before initiating a curing process within curing chamber 20 by monitoring fluid passage 22 for any change in pressure with transducer 26. These steps may begin, for example, after an operator engages the selectable icon 67 as discussed in the previous paragraph. Steps for determining a leak include opening the valve 24 along passage 22 to expose sealed fluid chamber 16 to the pressure from within manifold 30, subsequently closing valve 24 after a period of time, monitoring the pressure within passage 22 with transducer 26 after closing valve 24 to determine whether there is any pressure change P_{Δ} within passage 22 after closing valve 24. Determining a change in pressure P_{Δ}, during any phase of a curing operation, may occur in any of a variety of manners, including determining a pressure change and comparing the same to a threshold pressure change value, or by measuring a pressure and comparing the measured pressure to a threshold pressure value. See below and paragraph [0044] for exemplary manners of determining pressure changes for the purpose of identifying leaks. In an exemplary embodiment, manifold 30 is placed under vacuum and curing chamber 20 is at any pressure above vacuum (such as atmospheric pressure, for example), and after opening and closing valve 24 after a period of time (such as 30-60 seconds, for example), controller 50 receives signals from transducer 26 to determine whether there is any increase in pressure within passage 22, which would reflect the influx of curing chamber fluid through a leak in the sealed fluid chamber 16. If controller 50 identifies a leak, the controller 50 updates the status identifier 69 within a corresponding position display 65 to indicate the existence of a leak in association with a tire-membrane assembly 18. For example, a leak may be indicated by changing the status identifier 69 to red. Because small leaks may be acceptable, a leak may not be recognized on display 64 if the leak is not significant, that is, if the measured leak does not surpass a minimum pressure change threshold P_{Δ, L}, such as may be indicated by a tire curing specification. For example, a change in pressure threshold P_{Δ, L} indicating a significant leak may comprise a pressure change of at least 5 psia, 10 psia, 15 psia, or 20 psia.

To determine a change in pressure P_{Δ}, controller 50 may compare different fluid passage pressure P_{FP} signals obtained over time, or controller 50 may compare the membrane fluid passage pressure P_{FP} signals to manifold pressures P_{M} (or membrane pressure or vacuum source pressures). For example, when membrane fluid passage pressure P_{FP} should generally equal manifold pressures P_{M}, membrane fluid passage pressure P_{FP} may be compared directly to manifold pressures P_{M} at particular instances to determine a pressure change P_{Δ}, or a first differential between curing chamber pressure P_{C} and manifold pressures P_{M} at particular instances may be compared to a second differential between curing chamber pressure P_{C} and membrane fluid passage pressure P_{FP} at particular instances to determine a pressure change P_{Δ}. Other methods for determining pressure changes and leaks may be employed. For example, In an undesired change in pressure P_{Δ} may be determined by comparing a measured pressure P_{FP} with a pressure threshold P_{L}, whereby an undesired change may be identified if reaching or exceeding the pressure threshold P_{L}, where such threshold value may represent a particular deviation from P_{M}, P_{C}, or an earlier obtained value for P_{FP}, for example.

Upon receiving acknowledgement that a sufficient leak exists, the operator may remove the respective tire-membrane assembly 18 from the curing chamber 20 or choose to let the assembly 18 remain, even though the associated tire will have to be reprocessed for subsequent curing. Once controller 50 determines that no leaks are present in any tire-membrane assembly 18 contained within curing chamber 20, a process for curing the retreaded tires begins. In the alternative, if controller 50 determines the presence of leaks, an operator may override the controls and choose to cure the assemblies 18 with a known cure in hopes that the seal may occur as the curing process begins. And if no seal in fact arises, the tire-assembly 18 can be isolated by closing valve 24 is the leak continues according to the methods discussed herein.

During the curing process, transducers 19, 26, 48 and controller 50 continue to monitor the tire-membrane assemblies 18 for leaks. Each transducer 26 is arranged along a membrane fluid passage between a flow restrictor 28 and a curing membrane or curing chamber. Flow restrictor 28 controls or limits the flow rate along the fluid passage. In operation, the restrictor 28 may allow fluid flow rates associated with small leaks pass through the restrictor, while increased flow rates associated with greater leaks within a tire-member assembly are not allowed to pass completely, and therefore causes a back-up in pressure on the curing member side of the flow restrictor. A transducer 26 is able to measure this increase in pressure, while the controller 50 uses these measurements to determine if the leak is sufficiently large.

According to a particularly defined curing process (i.e., a curing specification), pressures within either or both the curing chamber 20 and the sealed fluid chamber 16 within each tire-membrane assembly 18 may change at different stages of a curing process. For example, the sealed fluid chamber 16 may initially be under vacuum and later be increased to remain at a constant pressure above vacuum for a period of time, while the curing chamber pressure P_{C} may begin at a constant pressure P_{C, X} for an initial period to later increase to a constant pressure P_{C, Y} for a second period of time. Meanwhile, transducer 26 and controller 50 continue to monitor the pressure within membrane fluid passage 22 for any non-conforming change in pressure, such as when, for example, the pressure within any chamber is to remain constant. If controller 50 determines a change in pressure P_{Δ} is acceptable, such as being less than a threshold value P_{Δ, L}, for example, then flow restrictor 28 continues to operate and allow sufficient passage of fluid flow associated with smaller leaks, if present. If, however, controller 50 determines a change in pressure P_{Δ} is significant, such as being above a threshold value P_{Δ, L}, for example, an undesired leak is identified and controller 50 responds by automatically closing the valve 24 associated with the leak. Exemplary methods for determining a change in pressure and an undesired leak are discussed in paragraphs [0043]-[0044] above. Controller 50 also identifies the tire-membrane assembly 18 that has been determined to have a leak and a non-confirming cure, which may be accomplished through the user-interface 62 or any other means of notification known to one of ordinary skill in the art, such as via a printer or audible sound. By automatically closing the corresponding valve 24, an undesired increase (or decrease) in pressure within the membrane fluid passage 22 will not sufficiently continue into the manifold 30 and into any other membrane fluid passage 22 to ultimately affect other tire-membrane assemblies 18. This prevents other retreaded tires 12 from experiencing non-confirming cures, limits the non-conforming cure to the tire 12 associated with the leak. This is a significant improvement over prior art systems, as this can avoid the costs and time associated with having to reprocess all the tires contained within a curing chamber when experiencing a non-conforming cure.

While this invention has been described with reference to particular embodiments thereof, it shall be understood that such description is by way of illustration and not by way of limitation. Accordingly, the scope and content of the invention are to be defined only by the terms of the appended claims.

1. A method for curing retreaded tires comprising the step of:
placing a plurality of tire-membrane assemblies within a tire curing chamber of a tire curing system, each tire-membrane assembly comprising a retreaded tire and a flexible curing membrane installed about at least a portion of the retreaded tire to form a sealed fluid chamber between the membrane and the tire;
connecting a membrane fluid passage to each curing membrane of each tire-membrane assembly where each passage extends in fluid communication between one of the curing membranes and a pressure source and/or a vacuum source, each membrane fluid passage including a transducer for measuring pressure within the passage;
initiating a curing process whereby the fluid within the curing chamber is heated to a desired temperature and pressurized to a desired pressure;
receiving a one or more signal responses from each transducer, each signal response being generated as a function of the fluid pressure contained within the one of the membrane fluid passages;
determining through a controller whether the one or more signal responses received in the prior step indicate an undesired change in pressure in each corresponding curing membrane;
closing a valve in operable communication with each membrane fluid passage determined by the controller in the preceding step to have experienced an undesired change in pressure, the step of closing being accomplished by the controller sending a signal for the valve to close.

2. The method of claim 1, wherein each membrane fluid passage includes a flow restrictor, each flow restrictor arranged such that the transducer of the passage is positioned between the flow restrictor and the curing membrane connecting portion of the envelop fluid passage.

3. The method of claim 1 wherein the step of determining includes comparing the one or more signal responses received in the step of receiving for each of the fluid passages to one or more signals responses received from a transducer in a manifold to determine whether the undesired change in pressure is present within the curing membrane, the manifold signals being generated as a function of the fluid pressure contained within the manifold.

4. The method of claim 1, wherein:
a manifold forms the membrane pressure source, the manifold including a manifold transducer for measuring pressure within the manifold;
the step of receiving includes receiving one or more signal responses from the manifold transducer, the one or more signal responses generated as a function of the fluid pressure contained within the manifold, and receiving one or more signal responses from a curing chamber transducer, the one or more signal responses generated as a function of the fluid pressure contained within the curing chamber; and,
the step of determining includes calculating a first difference between a curing chamber pressure and a manifold pressure at a given time based upon the signals received during the step of receiving, calculating a second difference between a curing chamber pressure and a manifold pressure at a given time based upon the signals received during the step of receiving, and comparing the first difference with the second difference to determine whether an undesired leak is present.

5. The method of claim 1 further comprising the step of:
identifying each tire-membrane assembly connected to each membrane fluid passage having a valve closed in the preceding step of closing, the step of identifying being facilitated by the controller.

6. The method of claim 5, where the step of indentifying is accomplished by a user-interface.

7. The method of claim 1 further comprising the steps of:
receiving, before the step of initiating a curing process, one or more signal responses from each transducer in operable communication with each membrane fluid passage, the one or more signal responses generated as a function of the fluid pressure contained within each corresponding membrane fluid passage over a desired period of time;
determining, before the step of initiating a curing process, through the controller whether the one or more signal responses received in the prior step indicate an undesired change in pressure;
identifying each tire-membrane assembly connected to each membrane fluid passage determined to have experienced an undesired change in pressure in the preceding step of determining, the step of indentifying being facilitated by the controller.

8. The method of claim 7, where the step of identifying is accomplished through a user-interface.

9. The method of claim 7 further comprising the step of:
opening the valve for a period of time and then subsequently closing the valve associated with each membrane fluid passage before the step receiving recited in claim 6 and after the step of connecting identified in claim 1, before the step of initiating a curing process.

10. The method of claim 1 further comprising the step of:
verifying the connection of each fluid passage to a tire-membrane assembly from the step of connecting before the step of initiating by receiving one or more signal responses from each transducer, the one or more signal responses generated as a function of the fluid pressure contained within the one of the membrane fluid passages over a desired period of time;
determining through the controller whether the one or more signal responses received in the prior step indicate a desired change in pressure in each corresponding curing membrane;
indicating through the controller that a proper connection was made between each membrane fluid passage and the corresponding tire-membrane assembly when the transducer corresponding to each such tire-membrane assembly fluid passage indicates a desired reduction in pressure subsequent to completing the step of connecting.

11. The method of claim 10, where the step of indicating is accomplished through a user-interface.

12. A computer program product including executable instructions embodied on a non-transitory computer readable storage medium, the computer program product providing instructions for determining leaks within a tire-membrane assembly during retreaded tire curing operations, the computer program comprising:
initiating instructions for initiating a curing process whereby the fluid within the curing chamber is heated to a desired temperature and pressurized to a desired pressure;
receiving instructions for receiving a one or more signal responses from each transducer, each signal response being generated as a function of the fluid pressure contained within the one of the membrane fluid passages;
determining instructions for determining through a controller whether the one or more signal responses received in the prior step indicate an undesired change in pressure in each corresponding curing membrane;
closing instructions for closing a valve in operable communication with each membrane fluid passage determined by the controller in the preceding step to have experienced an undesired change in pressure, the step of closing being accomplished by the controller sending a signal for the valve to close.

13. The computer program of claim 12 further comprising:
identifying instructions for identifying each tire-membrane assembly connected to each membrane fluid passage having a valve closed in the preceding step of closing, the step of identifying being facilitated by the controller.

14. The computer program of claim 12 further comprising:
receiving instructions for receiving, before the step of initiating a curing process, one or more signal responses from each transducer in operable communication with each membrane fluid passage, the one or more signal responses generated as a function of the fluid pressure contained within each corresponding membrane fluid passage over a desired period of time;
determining instructions for determining, before the step of initiating a curing process, through the controller whether the one or more signal responses received in the prior step indicate an undesired change in pressure;
identifying instructions for identifying each tire-membrane assembly connected to each membrane fluid passage determined to have experienced an undesired change in pressure in the preceding step of determining, the step of indentifying being facilitated by the controller.

15. The computer program of claim 12 further comprising:
verifying instructions for verifying the connection of each fluid passage to a tire-membrane assembly from the step of connecting before the step of initiating by receiving one or more signal responses from each transducer, the one or more signal responses generated as a function of the fluid pressure contained within the one of the membrane fluid passages over a desired period of time;
determining instructions for determining through the controller whether the one or more signal responses received in the prior step indicate a desired change in pressure in each corresponding curing membrane;
indicating instructions for indicating through the controller that a proper connection was made between each membrane fluid passage and the corresponding tire-membrane assembly when the transducer corresponding to each such tire-membrane assembly fluid passage indicates a desired reduction in pressure subsequent to completing the step of connecting.

16. A system for curing retreaded tires comprising:
a tire curing chamber in fluid communication with a chamber pressure source, the tire curing chamber being configured to receive a plurality of retreaded tires for curing, an curing membrane being mounted upon each retreaded tire to form a sealed fluid chamber about a tread area of the tire;
a plurality of membrane fluid passages, each of the membrane fluid passages extending between an curing membrane connecting portion of the membrane fluid passage and the membrane pressure source and/or the membrane vacuum source, each of the plurality of membrane fluid passages including:
a membrane fluid passage valve capable of controlling the flow of fluid through the passage; and,
a transducer operably connected to the membrane fluid passage for measuring the fluid pressure contained within the passage;
a controller in operable communications with each of the membrane fluid passage transducers and valves to control the fluid flow through each of the plurality of membrane fluid passages.

17. The system recited in claim 16, wherein a manifold comprises the membrane pressure source, where a manifold pressure source and a manifold vacuum source are in fluid communication with the manifold.

18. The system recited in claim 16, each of the plurality of membrane fluid passages including a flow restrictor, the flow restrictor arranged such that the transducer of the passage is positioned between the flow restrictor and the curing membrane connecting portion of the envelop fluid passage.

19. The system recited in claim 18, where the flow restrictor forms a flow passage reduction within each of the passages.

20. The system recited in claim 16 further comprising:
a user-interface having:
an identifying insignia for identifying each tire-membrane assembly connected to at least one of the plurality of membrane fluid passages within the curing chamber; and,
a status identifier for association with each tire-assembly connected to at least one of the plurality of membrane fluid passages within the curing chamber, the status identifier being used to identify whether or not an undesired pressure change is present within the corresponding membrane fluid passage.

21. The system recited in claim 16, the controller comprising a processor and a memory storage device that stores instructions executable by the processor, such executable instructions including the instructions of claim 11.
